(19) United States
(12) Patent Application Publication
(10) Pub. No.: US 2025/0017157 A1
(43) Pub. Date: Jan. 16, 2025

(54) Apparatus, Kit, and System for Horticulture

(71) Applicants: Boon Hian Kee, Singapore (SG); Boon Ching Ng, Singapore (SG); Blueacres Pte. Ltd., Singapore (SG)

(72) Inventors: Boon Hian Kee, Singapore (SG); Boon Ching Ng, Singapore (SG); Jay Sin Jie Liew, Singapore (SG)

(21) Appl. No.: 18/772,088

(22) Filed: Jul. 12, 2024

(30) Foreign Application Priority Data
Jul. 13, 2023 (SG) 10202302001Y

(51) Int. Cl. A01G 31/06; A01G 27/00

(52) U.S. Cl. CPC A01G 31/06; A01G 27/005

(57) ABSTRACT

An apparatus, kit, and system for horticulture. The apparatus has an elongate body that retains a plant therewithin, a flanged portion at a proximal end of the apparatus, and one or more fluid-handling portions. The body is inclined relative to a plane having the flanged portion with a distal end of the apparatus extending in a downwardly inclined altitude with respect to the flanged portion, with the flanged portion supporting the installation of the apparatus into an aperture of a vertical structure having levelled surfaces for fluid received by the apparatus to be handled by one or a combination of the fluid-handling portions. The apparatus may be in the form of one or more assemblable pieces. The apparatus is further part of a system with a vertical structure where a plurality of these apparatuses are installed thereon, and fluid dispensing means that dispenses fluid to the apparatuses.

### CROSS-REFERENCE TO RELATED APPLICATIONS

This application claims priority to, and the benefit of, Singapore Patent Application No. 10202302001Y, filed Jul. 13, 2023. The contents of that application are incorporated by reference herein in their entirety.

### TECHNICAL FIELD

Embodiments of the invention relate to an apparatus, kit, and a related system for performing horticulture. More specifically, an apparatus, kit, and system applicable to the cultivation of plants in a vertical farming setting.

### BACKGROUND

Horticulture involves the cultivation of plants, and it encompasses a wide range of techniques for plant breeding and plant production. It pertains to the optimisation of plant growth and development to produce high-quality crops for future generations. Among such techniques includes hydroponics, which is a soil-less plant cultivation technique, whereby plants are grown in nutrient-rich fluid for optimising their growth and development. Infrastructure involving hydroponics includes vertical farming, where plants are grown in vertical structures and are provided with nutrient-rich fluid.

There are a few disclosed technologies over the prior art that relate to horticulture, especially within a vertical farming setting. Among them include US20180168108A1, which discloses a growth system with growth pods. The growth system utilises gravity-fed irrigation and collection, with integrated illumination suitable for plant growth, and the growth pods installable in the system contain seeds or young plants and a growth medium. In some embodiments, the pods may be separate entities preloaded with dormant seeds and growth medium from a provider, and when installed in the system at an angle from vertical, germinate and grow when the system exposes the installed pods to predetermined irrigation and illumination cycles for the particular plant varieties in the pods.

Yet another disclosed technology is U.S. Pat. No. 10,772,270B2, which discloses an aeroponic column comprising a base and a planter section attached to the base. The planter section defines a hollow interior, a channel and plant holder openings adapted to receive a plant holder. Furthermore, there is a nutrient distributor attached to the planter section with fluid openings adapted to allow fluid to flow down the planter sections. Moreover, there is a conduit assembly operatively connected between the base and the nutrient distributor, and adapted to carry fluid from the base to the nutrient distributor. The conduit assembly comprises a conduit formed separately from the planter section. The said conduit extends through the channel of the planter section, and it has a male-threaded first end and a female-threaded second end.

However, the aforementioned prior arts may not be optimal technologies as they may be afflicted by one or more issues that may impede their effectiveness and scalability in plant cultivation. For example, since their plant-retaining bodies are not fully within the vertical structure for receiving fluid, there may be an inefficient receipt and distribution of fluids, whereby fluids leak out from the front of the vertical structure, or there may be dry spots about the plant-retaining bodies. Moreover, their plant-retaining bodies may require a specialised vertical structure that conforms to them, thus there is a substantial increase in the cost of fabrication.

Accordingly, it would be desirable for an apparatus, kit, and system for horticulture that is capable of addressing the shortcomings of the prior art. Preferably, the apparatus, kit, and system are efficient in receiving and distributing fluids for the nourishment of the plants. Moreover, the apparatus, kit, and system have scalability and are low in cost as a less-specialised vertical structure is required for their installation, i.e. the apparatus and kit conform to the vertical structure instead of vice versa.

### BRIEF SUMMARY

Embodiments of the present invention provide an apparatus for horticulture that cultivates plants, preferably in a vertical farming setting. An apparatus according to one embodiment of the present invention has a hollow body that retains a plant therein. The apparatus is further formed with (i) a flanged portion that shall allow it to be installed at an aperture of a vertical structure that is in the form of a partition with levelled surfaces, and (ii) one or more fluid-handling portions that receive and distribute fluid accordingly. The apparatus may also be in an embodiment whereby it is in the form of a kit of parts, in which there are one or more assemblable pieces that may define a fixture-adaptor pair, with the adaptor being installed at the aperture of the vertical structure, and the fixture, having a body that retains a plant therein, being inserted thereinto the adaptor. A system for horticulture involving the apparatus in its various embodiments is further provided.

The advantages of embodiments of the present invention are as follows. First, the present invention is compatible with simple vertical structures that have levelled or flat surfaces. Second, the present invention provides ease in transplanting plants as a horticulturist or a plant cultivator can easily drop new seedlings quickly, thereby decreasing lead time in the planting process. Third, the present invention provides easy removal of plants for their harvest, thereby decreasing lead time in the harvesting process. Fourth, the present invention provides a robust distribution of fluids that has high efficiency and accuracy. Fifth, the present invention only requires a growing medium (substrate), and it does not require a substrate support or growing support for retaining fluid, thereby reducing the time required for its cleaning. Sixth, the present invention in its various embodiments offers a degree of customizability and interchangeability, thereby making it suitable for a large variety of system design choices.

An embodiment of the present invention relate to an apparatus for horticulture, comprising an elongated body that retains a plant therewithin, a flanged portion at a proximal end of the apparatus, and one or more fluid-handling portions. The body is inclined relative to a plane having the flanged portion with a distal end of the apparatus extending in a downwardly inclined altitude with respect to the flanged portion, with the flanged portion supporting the installation of the apparatus into an aperture of a vertical structure having levelled surfaces for fluid received by the apparatus to be handled by one or a combination of the fluid-handling portions.

Preferably, regarding the apparatus, the fluid-handling portions include a first fluid-channeling portion in which the flanged portion extends therefrom, and a second fluid-channeling portion that is formed on the first fluid-channeling portion. The first fluid-channeling portion directs received fluid away from the apparatus, and the second fluid-channeling portion directs fluid towards the body.

Preferably, regarding the apparatus, the fluid-handling portions further include a fluid-collecting portion formed on the body, and at least one fluid-draining portion formed on the body and may be opposed to the fluid-collecting portion. The fluid-collecting portion allows receipt of fluid from the environment and/or itself into the body, and the fluid-draining portion drains excess fluid within the body away from the apparatus.

Preferably, regarding the apparatus, the fluid-draining portion is at a substantial distance away from the distal end of the apparatus for retaining a portion of received fluid within the body for immersing roots of the plant therein.

Preferably, regarding the apparatus, the fluid-draining portion is formed with an outline that is substantially tapered towards the distal end of the apparatus for guiding root growth of a plant to be external of the body for its aeration.

Preferably, the apparatus further comprises a fastening mechanism formed along a lateral surface of the first fluid-channeling portion as a set of protrusions for providing a support at the proximal end of the apparatus as the apparatus is installed on the vertical structure.

Preferably, the apparatus further comprises an orientation marker formed on the flanged portion for serving as an indication of a proper orientation of the apparatus whereby it is at a topmost level along the flanged portion.

Optionally, regarding the apparatus, the first fluid-channeling portion and the second fluid-channeling portion are part of a first piece, and the fluid-collecting portion and the fluid-draining portion are part of a second piece. The first piece and the second piece are capable of being assembled to form the apparatus. Preferably, the first piece and the second piece each include a connector that is mateable with each other for the first piece and the second piece to be detachably connected for their assembly.

Preferably, regarding the apparatus, the body is inclined relative to a plane having the flanged portion with a distal end of the apparatus extending in a downwardly inclined altitude with respect to the flanged portion at an angle that is substantially between 50° and 80°.

Another embodiment of the present invention relates to a system for horticulture, comprising a vertical structure having levelled surfaces, formed with a plurality of apertures, a fluid dispensing means for dispensing fluid, and a plurality of apparatuses for horticulture that each includes an elongated body that retains a plant therewithin, a flanged portion at a proximal end of the apparatus, and one or more fluid-handling portions. The body of each apparatus is inclined relative to a plane having the flanged portion with a distal end of the apparatus extending in a downwardly inclined altitude with respect to the flanged portion, with the flanged portion supporting the installation of the apparatus into one aperture of the vertical structure for fluid dispensed by the fluid-dispensing means to be received by the apparatus for it handled by one or a combination of the fluid-handling portions.

Preferably, regarding the system, the fluid-handling portions of the apparatus include a first fluid-channeling portion in which the flanged portion extends therefrom, and a second fluid-channeling portion that is formed on the first fluid-channeling portion. The first fluid-channeling portion directs received fluid away from the apparatus, and the second fluid-channeling portion directs fluid towards the body.

Preferably, regarding the system, the fluid-handling portions of the apparatus further include a fluid-collecting portion formed on the body, and at least one fluid-draining portion formed on the body and may be opposed to the fluid-collecting portion. The fluid-collecting portion allows receipt of fluid from the environment and/or itself into the body, and the fluid-draining portion drains excess fluid within the body away from the apparatus.

Preferably, regarding the system, the fluid-draining portion of the apparatus is at a substantial distance away from the distal end of the apparatus for retaining a portion of received fluid within the body for immersing roots of the plant therein.

Preferably, regarding the system, the fluid-draining portion of the apparatus is formed with an outline that is substantially tapered towards the distal end of the apparatus for guiding root growth of a plant to be external of the body for its aeration.

Preferably, regarding the system, the apparatus further comprises a fastening mechanism formed along a lateral surface of the first fluid-channeling portion as a set of protrusions for providing a support at the proximal end of the apparatus as the apparatus is installed on the vertical structure.

Preferably, regarding the system, the apparatus further comprises an orientation marker formed on the flanged portion for serving as an indication of a proper orientation of the apparatus whereby it is at a topmost level along the flanged portion.

Optionally, regarding the system, the apparatus is in the form of assemblable pieces where the first fluid-channeling portion and the second fluid-channeling portion are part of a first piece, and the fluid-collecting portion and the fluid-draining portion are part of a second piece. The first piece and the second piece are capable of being assembled to form the apparatus. Preferably, the first piece and the second piece of the apparatus each include a connector that is mateable with each other for the first piece and the second piece to be detachably connected for their assembly.

Yet another embodiment of the invention relates to a kit of parts assembly for horticulture, comprising a first piece and a second piece, with an elongate body that retains a plant therewithin being part of the second piece, a flanged portion being part of either one or both the first piece and the second piece, and one or more fluid-handling portions being part of either one or both the first piece and the second piece. The first piece and the second piece are detachably connectable with each other, and assembly of the pieces allows the body to be inclined relative to a plane having the flanged portion with a distal end of the assembled piece extending in a downwardly inclined altitude with respect to the flanged portion, with the flanged portion supporting the installation of the assembled piece into an aperture of a vertical structure having levelled surfaces for fluid received by the assembled piece to be handled by one or a combination of the fluid-handling portions.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

To facilitate an understanding of the present invention, there is illustrated in the accompanying drawings the preferred embodiments, from an inspection of which when considered in connection with the following description, the invention, its construction and operation and many of its advantages would be readily understood and appreciated.

FIG. 1 is a diagram illustrating a perspective view of the present invention, whereby the apparatuses are installed onto a vertical structure, being a partition, via apertures of the partition.

FIG. 2 is a diagram illustrating a sectional side view of the present invention, whereby the apparatuses are installed onto a partition via apertures of the partition, with plants growing therein the apparatuses.

FIG. 3 is a diagram illustrating an example installation of the apparatus of the present invention in its first embodiment onto the partition via an aperture of the partition.

FIGS. 4a to 4d are diagrams illustrating the apparatus's first embodiment. In particular, FIG. 4a illustrates a perspective view of the said embodiment, FIG. 4b illustrates a top view of the said embodiment, FIG. 4c illustrates a rear view of the said embodiment, and FIG. 4d illustrates a side view of the said embodiment.

FIG. 5 is a diagram illustrating an example installation of the apparatus of the present invention in its second embodiment, whereby it is in the form of assemblable pieces, onto the partition via an aperture of the partition.

FIGS. 6a to 6d are diagrams illustrating a first piece of the apparatus's second embodiment. In particular, FIG. 6a illustrates a rear view of the said piece, FIG. 6b illustrates a front view of the said piece, FIG. 6c illustrates a top view of the said piece, and FIG. 6d illustrates a side view of the said piece.

FIGS. 7a to 7c are diagrams illustrating a second piece of the apparatus's second embodiment. In particular, FIG. 7a illustrates a rear view of the said piece, FIG. 7b illustrates a top view of the said piece, and FIG. 7c illustrates a side view of the said piece.

FIGS. 8a and 8b are diagrams illustrating alternative configurations of the first fluid-channeling portion for both embodiments of the apparatus. In particular, FIG. 8a illustrates the first fluid-channeling portion of the apparatus's first embodiment in an alternative configuration, and FIG. 8b illustrates the first fluid-channeling portion of the first piece of the apparatus's second embodiment in an alternative configuration.

FIGS. 9a to 9e are diagrams illustrating an alternative configuration for the fluid-draining portion of the apparatus of the present invention in its first embodiment. In particular, FIG. 9a illustrates a rear view of the said embodiment, FIG. 9b illustrates a side view of the said embodiment, FIG. 9d illustrates a top view of the said embodiment, and FIG. 9e illustrates a bottom view of the said embodiment. In particular, FIG. 9c illustrates the present invention in its first embodiment that has an alternative configuration of the first fluid-channeling portion.

FIGS. 10a and 10b are diagrams illustrating an alternative configuration for the fluid-draining portion for the apparatus of the present invention for the second piece of the second embodiment. In particular, FIG. 10a illustrates a rear view of the said piece of the embodiment, and FIG. 10b illustrates a bottom view of the said piece of the embodiment.

FIG. 11 is a diagram illustrating a sectional side view of the present invention, whereby the apparatuses are installed onto a partition via apertures of the partition, with plants growing therein the apparatus, further illustrating an example fluid distribution between the apparatuses.

FIG. 12 is a diagram illustrating a sectional side view of the present invention, whereby the apparatuses have first fluid-channeling portions of alternative configuration installed onto a partition via apertures of the partition, with plants growing therein the apparatus, further illustrating an example fluid distribution between the apparatuses.

### DETAILED DESCRIPTION

The present invention relates to an apparatus suitable for horticulture. The apparatus may also be realised as a kit of assemblable parts or pieces. A plurality of these apparatuses may be further implemented within a system that cultivates plants, preferably within a vertical farming setting.

According to the concept of the invention, the apparatus is a pod-like structure that is to be mounted onto a partition for the cultivation of a plant therewithin. The apparatus is structurally formed for it to be supportively mounted on the partition during installation of the apparatus. The apparatus is also structurally formed for retaining, irrigating, aerating, and nourishing the plant cultivated therewithin. Furthermore, embodiments of the apparatus may include it being in the form of assemblable parts that provide a degree of flexibility in its usage and deployment.

The invention will now be described in greater detail, by way of example, with reference to the figures. For ease of reference, common reference numerals or series of numerals will be used throughout the figures when referring to the same or similar features common to the figures.

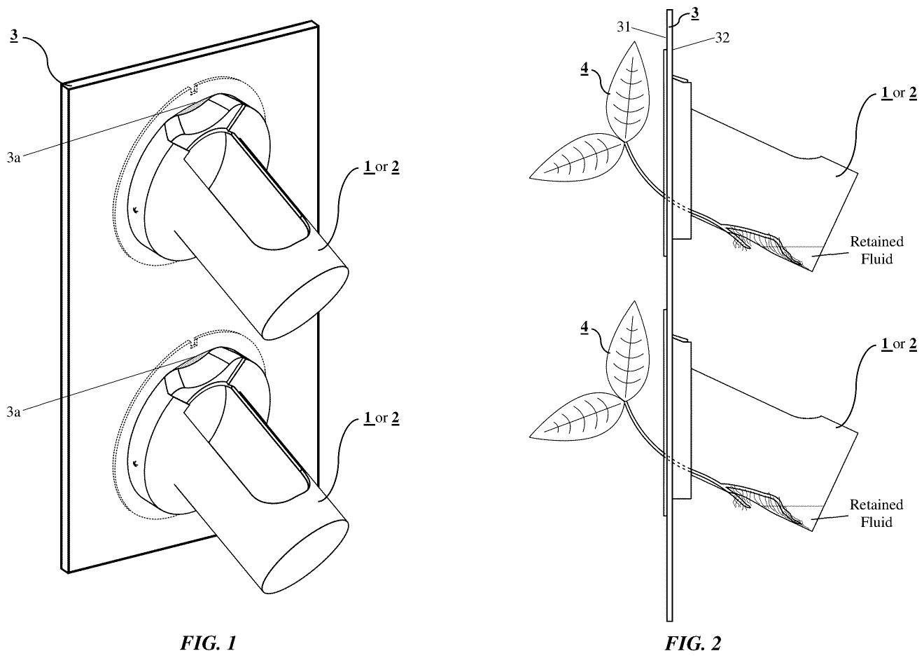

FIG. 1 illustrates a perspective view of the present invention, whereby the apparatuses 1, 2 are installed onto a vertical structure, being a partition 3, via apertures 3a of the partition 3. Whereas, FIG. 2 illustrates a sectional side view of the present invention, whereby the apparatuses 1, 2 are installed onto a partition 3 via apertures 3a of the partition 3, with plants 4 retained and grown within each apparatus 1, 2. Preferably, there is included a growing medium therewithin the apparatus 1, 2, but is omitted in FIG. 2 for clarity of the present invention.

As shown in FIGS. 1 and 2, one or more apparatuses 1, 2 are to be installed on a partition 3. In particular, the apparatuses may be of a first embodiment 1 or a second embodiment 2. Both embodiments may be substantially similar, with their difference being their ability to be assembled. More specifically, the apparatus of the first embodiment 1 may be of a single piece that is installed onto the partition 3, whereas the apparatus of the second embodiment 2 may be of multiple pieces capable of being assembled into said apparatus as it is installed onto the partition 3.

The partition 3, being a vertical structure, is preferably a rigid and upright panel with a plurality of apertures 3a that allows for installation of the apparatuses 1, 2 thereon. It may also be part of a pillar. Moreover, partition 3 may be defined to have a first surface 31 and a second surface 32. The first surface 31 is preferably an outward-facing surface that receives light for photosynthesis and phototropism of the plant 4 cultivated within the apparatuses 1, 2. Whereas, the second surface is preferably an inward-facing surface that receives fluids, such as water or nutrient solutions, for the growth and nourishment of the plant. Both of these surfaces 31, 32 are levelled with a substantial flatness and with little to no curvature.

Regarding the apertures 3a of the partition 3, they are preferably holes bored by the use of a hole saw or a drill bit. The size of the apertures 3a, in terms of its diameter, may range from 3 cm to 7 cm, but it is most preferably 5 cm. The size of the apertures 3a may also be large and have a diameter of around 15 cm to 20 cm, for larger-sized apparatuses 1, 2 or flowering pots to be accommodated therein. The apertures 3a on the partition 3 are to be adjacent and equidistant to one another. Hence, there may be a column, a matrix, or an array of apertures 3a formed on the partition 3, with each aperture 3a positioned and arranged to be directly beside, above or below each other. Moreover, the apertures 3a on the partition 3 are to be of the same size. However, it is to be noted that the descriptions of the apertures 3a on the partition 3 may not be limited to as described, and they may have varying sizes, or be formed in any other permissible manner on the partition 3.

Regarding the structural properties of partition 3, it is preferably able to withstand humid environments, as such it may be, to a certain degree, moisture-resistant and heat-resistant. Preferably as well, partition 3 may have a substantial tensile strength, for it to sufficiently support stress forces exerted by the plurality of apparatuses 1, 2 installed thereon, without bending or breaking.

With this, the partition 3, may be, by way of example, to be made of acrylonitrile butadiene styrene (ABS) plastic, polyvinyl chloride (PVC) plastic, polycarbonate plastic, or the like.

In the context of the present invention, it is to be noted that plants 4 may refer to any kind of plant life that may be cultured, preferably compatible with hydroponics and/or aeroponics. The plants may be, by way of example, varieties such as leaf vegetables, herbs, tomatoes, or the like.

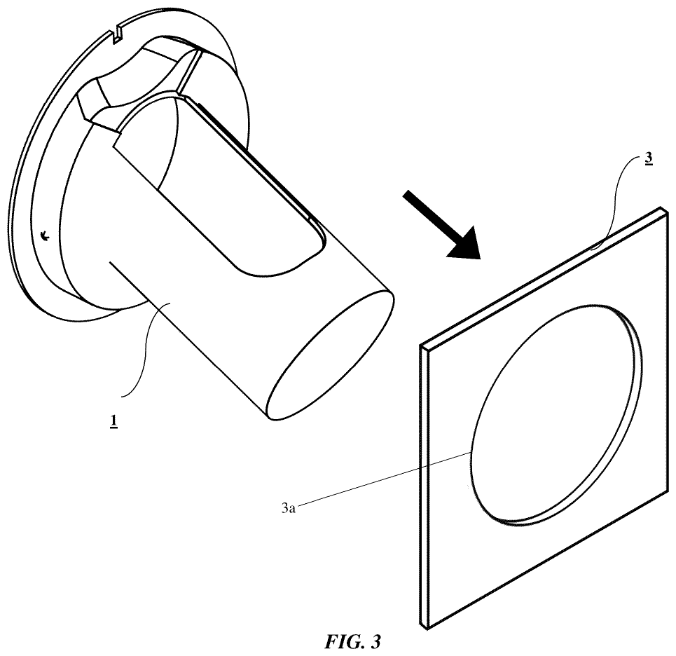

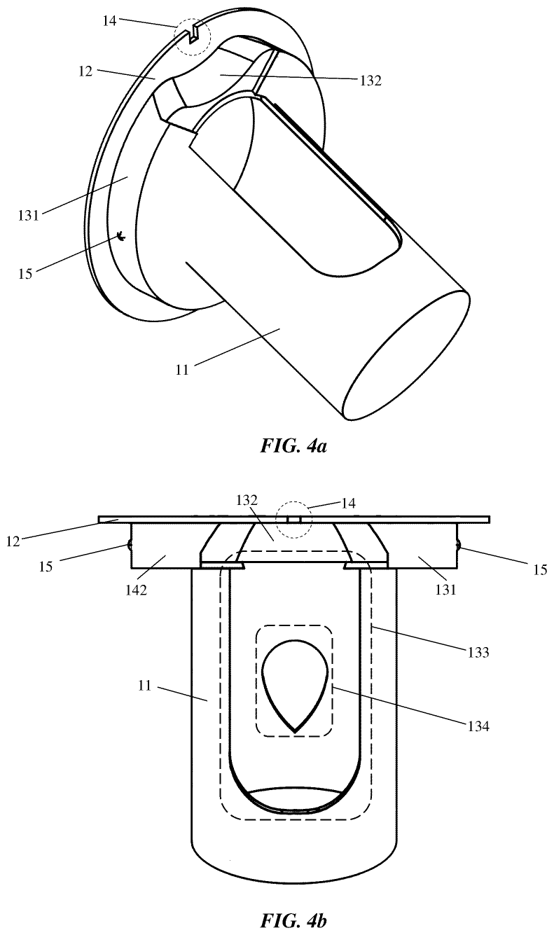

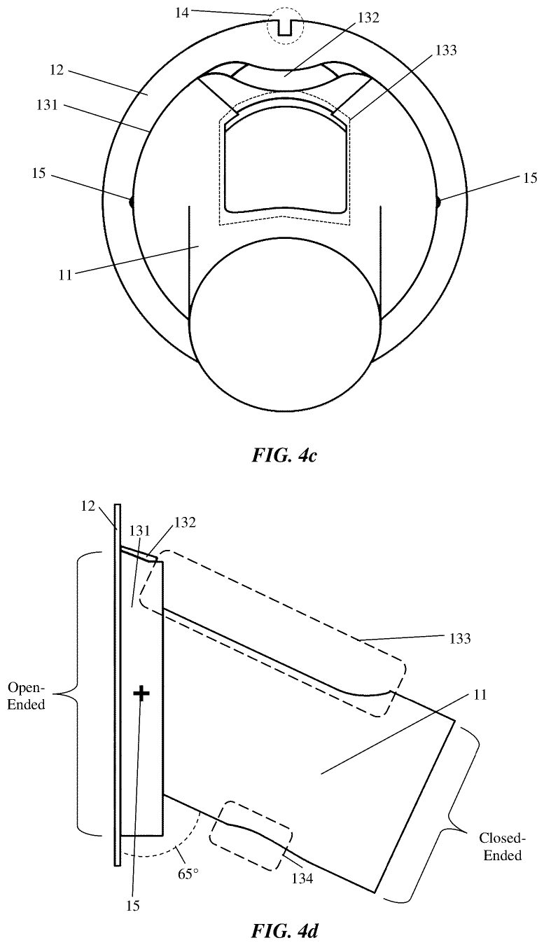

FIGS. 3 to 4d illustrate the apparatus of the present invention in its first embodiment 1. More specifically, FIG. 3 illustrates an example installation of the apparatus of the present invention in its first embodiment 1 onto the partition 3 via an aperture 3a of the partition 3. FIGS. 4a to 4d illustrate one or more views of the apparatus in its first embodiment 1, with FIG. 4a illustrating its perspective view, FIG. 4b illustrating its top view, FIG. 4c illustrating its rear view, and FIG. 4d illustrating its side view. From hereon, the apparatus in its first embodiment 1 is likewise referred to as “first embodiment”.

As shown in FIGS. 3 to 4d, the first embodiment 1 has a body 11 that is barrel-like, and is further elongate in such a way that its proximal end and its distal end are inclined with respect to each other. More specifically, the distal end is at a downwardly inclined altitude with respect to the proximal end at an angle. This angle may be between 50° and 80°, but is most preferably 65°. Preferably, the proximal end is open-ended for shoots of a plant 4 to emerge therefrom during its growth, while the distal end is closed-ended for retaining the plant 4 therewithin. About the body 11 there is disposed one or more features that contribute to its installation on the partition 3 and its handling of the plant 4 retained therein. In particular, there is included a flanged portion 12, fluid-handling portions such as a first fluid-channeling portion 131, a second fluid-channeling portion 132, a fluid-collecting portion 133, and a fluid-draining portion 134, an orientation marker 14, and a fastening mechanism 15. It is to be noted that the proximal end of the first embodiment 1 may include the flanged portion 12, the first fluid-channeling portion 131, and the second fluid-channeling portion 132.

Regarding the first embodiment 1, its first fluid-channeling portion 131 is a substantively annular structure that extends perpendicularly and outwardly from the circumference of its body 11, having an outer diameter that is much larger than its body 11 but an inner diameter that is substantially the same as its body 11. Along the lateral surface of the first fluid-channeling portion 131 lies the second fluid-channeling portion 132, which is a concave segment that tapers towards the fluid-collecting portion 133. The flanged portion 12 is yet another annular structure that extends perpendicularly and outwardly from the circumference of the first fluid-channeling portion 131, having an outer diameter that is much larger than the first fluid-channeling portion 131 but having an inner diameter that is substantially the same as the first fluid-channeling portion 131 and a lateral surface that is thinner compared to the first fluid-channeling portion 131.

Regarding the first embodiment 1, the flanged portion 12 supports the mounting of the first embodiment 1 onto the partition 3 during installation of the first embodiment 1. More specifically, the flanged portion 12 is to rest against the first surface 31 of the partition 3 as the first embodiment 1 is inserted into the aperture 3a, while the rest of the first embodiment 1 exits and protrudes outwardly from the second surface 32 of the partition 3.

Regarding the first embodiment 1, its body 11 is formed with the fluid-collecting portion 133 and the fluid-draining portion 134. In particular, the fluid-collecting portion 133 and the fluid-draining portion 134 are positioned to be in opposition with each other along the body 11. The relative size of the fluid-collecting portion 133 is preferably larger than the fluid-draining portion 134. Moreover, the fluid-collecting portion 133 may be a cutout that extends from an area along the body 11 that is adjacent to the second fluid-channeling portion 132 to the distal end of the body 11, which is also the distal end of the first embodiment 1. The fluid-draining portion 134 may be a cutout that is at a substantial distance away from the distal end of the body 11. For the fluid-collecting portion 133, its outline is substantially rectangular-shaped with rounded edges at the distal end of the body 11. For the fluid-draining portion 134, its outline is substantially tapered with it having a diminishing opening towards the distal end of the body 11, more specifically, it is teardrop-shaped with a rounded edge in the direction of the proximal end and a pointed edge in the direction of the distal end.

Regarding the first embodiment 1, along the flanged portion 12 there is disposed the orientation marker 14 that serves as an indication of the orientation and positioning of the first embodiment 1 as it is installed onto the partition 3. Furthermore, the orientation marker 14 is preferably adjacent to the second fluid-channeling portion 132. The orientation marker 14 is to indicate that the first embodiment 1 is inserted into the aperture 3 at a correct orientation, wherein its second fluid-channeling portion 132 is facing an upward direction, with its proximal end pointed towards an upward direction while the distal end pointed towards a downwards direction. During installation of the first embodiment 1 on the partition 3, it is most preferable that the orientation marker 14 is substantively made to be at a topmost level along the flanged portion 12 as the flanged portion 12 rests on the partition 3.

Regarding the first embodiment 1, along the first fluid-channeling portion 131 there is disposed the fastening mechanism 15, which is preferably in the form of a set of protrusions that are about the lateral surface of the first fluid-channeling portion 131. In particular, there are at least two protrusions that are substantially collinear with respect to each other. As the first embodiment 1 is installed onto the partition 3, the fastening mechanism 15 allows it to be supportively mounted thereon in a fashion similar to snap fitting. More specifically, during installation, the fastening mechanism 15 is forced through the aperture 3a of the partition 3, from the first surface 31 to the second surface 32, for the flanged portion 12 to become in contact with the first surface 31. As the fastening mechanism 15 emerges from the aperture 3a at the side of the second surface 32, the apparatus 1 may now be deemed to be properly installed on the partition 3 as it is now snugly fitted into the aperture 3a. With this, the first embodiment 1 is installed onto the partition 3 with the fastening mechanism 15 providing a support at the proximal end of the first embodiment 1. The first embodiment 1 may now not be removed from the partition unless a substantial force is applied for the fastening mechanism 15 to be forced through the aperture 3a of the partition 3, from the second surface 32 to the first surface 31.

Installation of the first embodiment 1 may be as shown in FIG. 3. As shown, the first embodiment 1 inserted into an aperture 3a of the partition 3 from its distal end, for its flanged portion 12 at its proximal end to be against a first surface 31 of the partition 3, and its fastening mechanism 15 supporting it to be in place by being against a second surface 3 of the partition 3. Preferably, the orientation marker 14 is made to be at a topmost level along the flanged portion 12.

Likewise, for the uninstallation of the first embodiment 1, the first embodiment 1 may be forcefully detached from the partition 3 by pulling its flanged portion 211, or pushing its distal end, for the protrusions 15 to emerge at the first surface 31 of the partition 3, thereby freeing the first embodiment 1 from the partition 3.

Regarding the first embodiment 1, the flanged portion 12 also contributes to the supportive mounting of the first embodiment 1 on the partition 3 much like the fastening mechanism 15. Since the distal end of the first embodiment 1 is inclined downwards with respect to the proximal end, hence, the weight of its body 11 may cause its flanged portion 12 to be in contact with the partition 3 without human intervention. With this, the first embodiment 1 is installed onto the partition 3 with the flanged portion 12 providing a support for the proximal end of the first embodiment 1 as well. The weight of the body 11 may further include the weight of the fluids and the plant 4 retained therein.

Regarding the first embodiment 1, the first fluid-channeling portion 131 and the second fluid-channeling portion 132 are involved in managing fluid in the first embodiment 1. More specifically, fluid received on any part of the lateral surface of the first fluid-channeling portion 131 may be made to flow towards its bottom and away from the first embodiment 1 by the influence of gravity, whereas fluid received at the second fluid-channeling portion 132 may be made to flow towards the fluid collecting portion 133. Moreover, in the case where the second fluid-channeling portion 132 becomes brimmed with fluid (i.e. fluid gathers thereupon faster than it can channel), the excess fluid may spill over to the lateral surface of the first fluid-channeling portion 131 to flow therealong towards its bottom and away from the first embodiment 1 by the influence of gravity.

Regarding the first embodiment 1, the fluid-collecting portion 133 and the fluid-draining portion 134 are also involved in managing fluid in the first embodiment 1. More specifically, the fluid-collecting portion 133 is to collect fluid that the first embodiment 1 receives from the external environment sources and/or itself for the fluid to be within the body 11 of the first embodiment 1 as shown in FIG. 2, and/or received by a root system of the retained plant 4. Whereas the fluid-draining portion 134 is to remove excess fluid from the body 11 of the first embodiment 1. Since the fluid-draining portion 134 is configured so that it may be at a substantial distance from the inclined distal end of the body 11, an amount of fluid may be retained in the body 11. However, once the level of this fluid reaches the fluid-draining portion 134, the excess fluid is removed from the body 11 of the first embodiment 1 to maintain the level of fluid within body 11.

Regarding the first embodiment 1, the fluid-draining portion 134 is further involved in providing aeration of the roots of the plant 4, which is shown in FIG. 2. More specifically, the outline of the fluid-draining portion 134 may guide root growth of the plant 4 during its various growth stages, for a portion of the roots of the plant 4 to grow out from the body 11 for its aeration, and for a portion of the roots of the plant 4 to be retained within the body 11 for its nourishment by being immersed in the retained fluid for receiving fluid and nutrients therefrom. It is still noted that the portion of the roots of the plant 4 that grew out from the body 11 may still receive fluid from the fluid-collecting portion 131 and/or from the excess fluid that is removed from the body 11 via the fluid-draining portion 134.

FIGS. 5 to 7c illustrate the apparatus of the present invention in its second embodiment 2, whereby it is in the embodiment of assemblable pieces that define a fixture-adaptor pair, which include a first piece 21 and a second piece 22. From hereon, the apparatus in its second embodiment 2 is likewise referred to as “second embodiment”.

FIG. 5 illustrates an example installation of the second embodiment 2 onto the partition 3 via an aperture 3a of the partition 3.

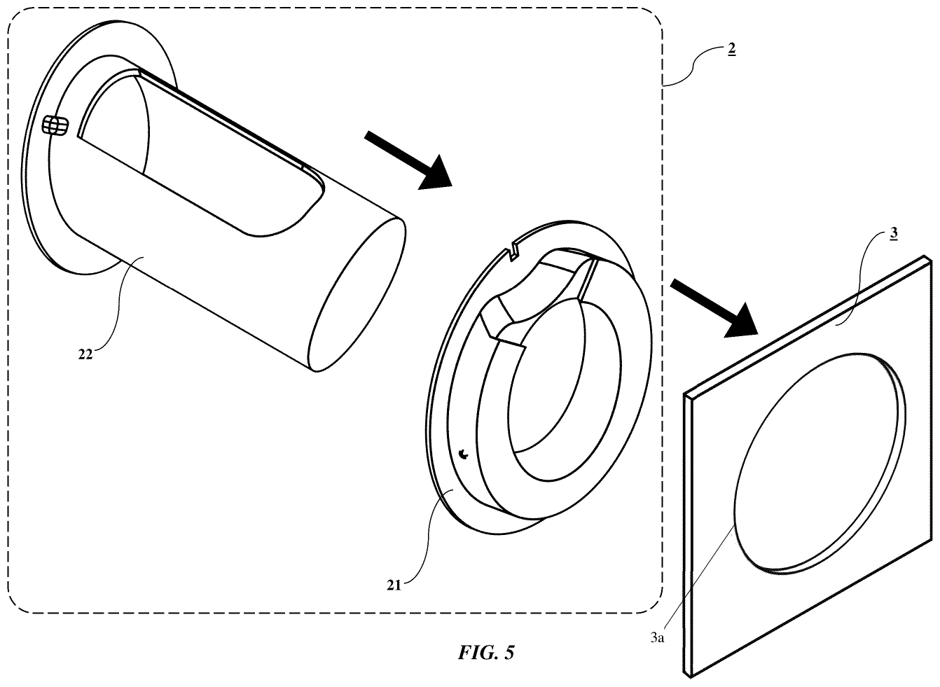

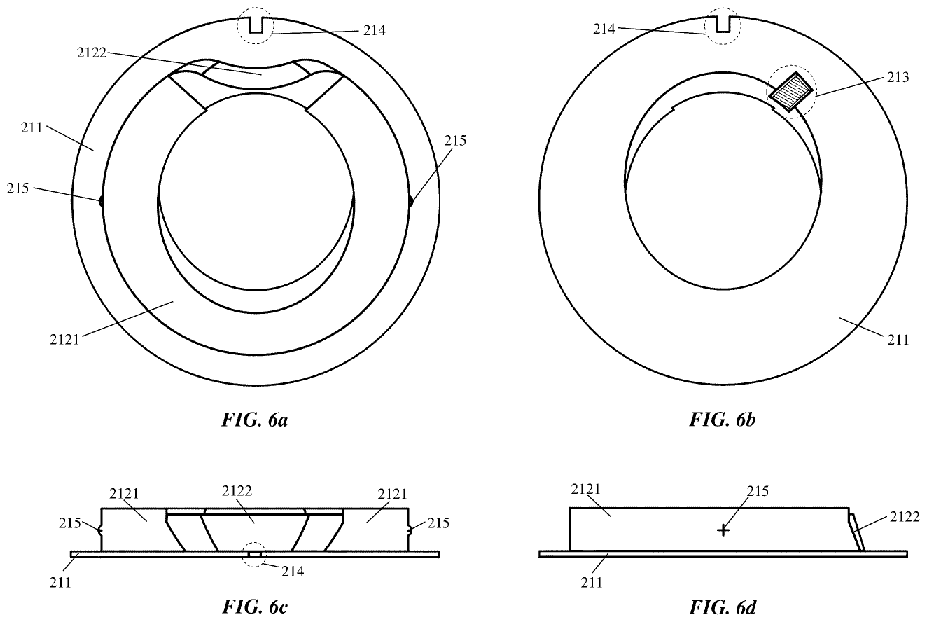

FIGS. 6a to 6d illustrate one or more views of the first piece 21 of the second embodiment 2, with FIG. 6a illustrating its front view, FIG. 6b illustrating its rear view, FIG. 6c illustrating its top view, and FIG. 6d illustrating its side view.

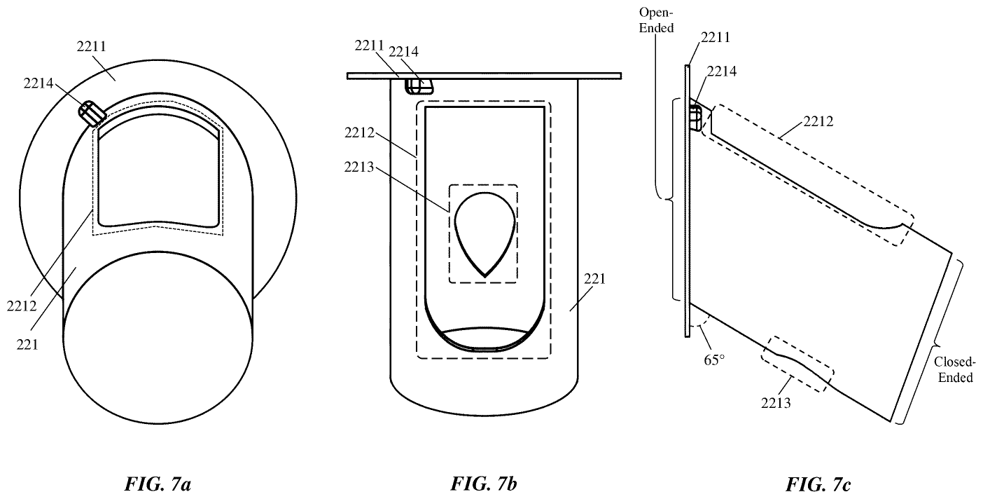

FIGS. 7a to 7c illustrate one or more views of the second piece 22 of the second embodiment 2, with FIG. 7a illustrating its rear view, FIG. 7b illustrating its top view, and FIG. 7c illustrating its side view.

With reference to FIGS. 5a to 5d, the first piece 21 of the second embodiment 2 is an overall annular structure that comprises a first flanged portion 211, fluid-handling portions that include a first fluid-channeling portion 2121 and a second fluid-channeling portion 2122, a first connector 213, an orientation marker 214, and a fastening mechanism 215.

Regarding the first piece 21 of the second embodiment 2, the first fluid-channeling portion 2121 is a substantively annular structure that is non-concentric. In other words, the inner circular perimeter of the said annular structure at its front side and the inner circular perimeter of the said annular structure at its rear side do not share an imaginary centre of the same. Preferably, the inner circular perimeter of the said annular structure at its rear side has a downward shift or offset with respect to the inner circular perimeter of the said annular structure at its front side.

Regarding the first piece 21 of the second embodiment 2, along the lateral surface of its first fluid-channeling portion 2121 lies the second fluid-channeling portion 2122, which is a concave segment that tapers towards the rear side of the first piece 21.

Regarding the first piece 21 of the second embodiment 2, the first flanged portion 211 is yet another annular structure that extends perpendicularly and outwardly from the circumference of the first fluid-channeling portion 2121. Preferably, the first flanged portion 211 has an outer diameter that is much larger than the first fluid-channeling portion 2121, but having an inner diameter that is substantially the same as the first fluid-channeling portion 2121 and a lateral surface that is thinner compared to the first fluid-channeling portion 2121.

Regarding the first piece 21 of the second embodiment 2, the first connector 213 is to mate with a mateable connector that may be part of another assemblable piece. Preferably, the first connector 213 is an indented segment on the rear side of the first piece 21, wherein the indented segment includes either one or both portions of the first fluid-channeling portion 2121 and portions of the first flanged portion 211.

Regarding the first piece 21 of the second embodiment 2, along the flanged portion 211 there is disposed the orientation marker 214 that serves as an indication of the positioning the first piece 21 as it is installed onto the partition 3. Furthermore, the orientation marker 214 is preferably adjacent to the second fluid-channeling portion 2122 of the first piece 21. The orientation marker 214 is to indicate that the first piece 21 is inserted into the aperture 3a at a correct orientation, wherein its second fluid-channeling portion 2122 is facing an upward direction. During installation of the first piece 21 on the partition 3, it is most preferable that the orientation marker 214 is substantively made to be at a topmost level along the flanged portion 211 as the flanged portion 211 rests on the partition 3.

Regarding the first piece 21 of the second embodiment 2, along the first fluid-channeling portion 2121 there is disposed the fastening mechanism 215, which is preferably in the form of a set of protrusions that are about the lateral surface of the first fluid-channeling portion 2121. In particular, there are at least two protrusions that are substantially collinear with respect to each other. As the first piece 21 is installed onto the partition 3, the fastening mechanism 215 allows it to be supportively mounted thereon in a fashion similar to snap fitting. More specifically, during installation, the fastening mechanism 215 is forced through the aperture 3a of the partition 3, from the first surface 31 to the second surface 32, for the flanged portion 212 to become in contact with the first surface 31. As the fastening mechanism 15 emerges from the aperture 3a at the side of the second surface 32, the first piece 21 may now be deemed to be properly installed on the partition 3 as it is now snugly fitted into the aperture 3a. With this, an assembled second embodiment 2 may be installed onto the partition 3 with the fastening mechanism 215 providing a support at a proximal end of the second embodiment 2. The first piece 21 may now not be removed from the partition unless a substantial force is applied for the fastening mechanism 215 to be forced through the aperture 3a of the partition 3, from the second surface 32 to the first surface 31.

With reference to FIGS. 7a to 7c, the second piece 22 of the second embodiment 2 has a body 221 is an overall barrel-like structure that comprises a second flanged portion 2211, fluid-handling portions that include a fluid collecting portion 2212 and a fluid-draining portion 2213, and a second connector 2214.

Regarding the second piece 22 of the second embodiment 2, its body 221 is further elongate in such a way that its proximal end and its distal end are inclined with respect to each other. More specifically, the distal end is inclined downwards with respect to the proximal end at an angle. This angle may be between 50° and 80°, but is most preferably 65°. Preferably, the proximal end is open-ended for shoots of a plant 4 to emerge therefrom during its growth, while the distal end is closed-ended for retaining the plant therewithin.

Regarding the second piece 22 of the second embodiment 2, the second flanged portion 2211 is an annular structure that extends perpendicularly and outwardly from the circumference of the body 221, having an outer diameter that is much larger than the body 221, but having an inner diameter that is substantially the same as the body 221 and having a lateral surface that is thin much like the first flanged portion 211 of the first piece 21 of the apparatus 2.

Regarding the second piece 22 of the second embodiment 2, its body 221 is formed with the fluid-collecting portion 2212 and the fluid-draining portion 2213. In particular, the fluid-collecting portion 2212 and the fluid-draining portion 2213 are positioned to oppose each other along the body 221. The relative size of the fluid-collecting portion 2212 is preferably larger than the fluid-draining portion 2213. Moreover, the fluid-collecting portion 2212 may be a cutout that extends an area along the body 211 that is adjacent to the second flanged portion 2212 to the proximal end of the body 221 to the distal end of the body 221. The fluid-draining portion 2213 may be a cutout that is at a substantial distance away from the distal end of the body 221. For the fluid collecting portion 2212, its outline is substantially rectangular-shaped with rounded edges at the distal end of the body 221. For the fluid-draining portion 2213, its outline is substantially tapered with it having a diminishing opening towards the distal end of the body 221, more specifically, it is teardrop-shaped with a rounded edge in the direction of the proximal end and a pointed edge in the direction of the distal end.

Regarding the second piece 22 of the second embodiment 2, the second connector 2214 is to mate with a mateable connector that may be part of another assemblable piece such as the first piece 21. Preferably, the second connector 2214 is a protruded segment that protrudes from the rear side of the second flanged portion 2211 and body 221 as a single segment.

Installation of the second embodiment 2 may be as shown in FIG. 5. As shown, the first piece 21 and the second piece 22 are assemblable to form an assembled second embodiment 2. In a first assembly example, the first piece 21 is inserted into an aperture 3a of the partition 3, preferably with its first flanged portion 211 being against a first surface 31 of the partition 3, and its fastening mechanism 215 supporting it to be in place by being against a second surface 3 of the partition 3. Preferably, the orientation marker 214 of the first piece 21 is made to point at a topmost level along the first flanged portion 211. Continuing from the first assembly example, the second piece 22 is then inserted through the first piece 21 for contact between their flanged portions 211, 2211, and for the first connector 213 and the second connector 2214 to mate. This concludes the description of the first assembly example.

Likewise, for the uninstallation of the assembled apparatus 2, the second piece 22 may be made to detach from the first piece 21 by overcoming the mated connection between the first connector 213 and the second connector 2214. Then, the first piece 21 may be forcefully detached from the partition 3 by pulling its first flanged portion 211 for the protrusions 215 to emerge at the first surface 31 of the partition 3, thereby freeing the first piece 21 from the partition 3.

Hence, the first piece 21 may be regarded as an adaptor, and the second piece 22 may be regarded as a fixture. They complement each other to form the fixture-adaptor pair since the first piece 21 makes an aperture 3a of a partition 3 adapt to the mounting of the second piece 22 during assembly and installation of the second embodiment 2.

Besides the first assembly example, the installation and uninstallation of the second embodiment 2 can be of any feasible order.

The assembled second embodiment 2 may be much like the first embodiment as shown in FIGS. 3 to 4d. In the assembled second embodiment 2, there is defined a proximal end and a distal end. The proximal end of the assembled second embodiment 2 may include the flanged portions 211, 2211, the first fluid-channeling portion 2121, and the second fluid-channeling portion 2122. The distal end of the assembled second embodiment 2 may be the distal end of the body 221.

The distal end of the assembled second embodiment 2 is at a downwardly inclined altitude with respect to the proximal end of the assembled second embodiment 2 at the aforementioned angle, since first piece 21, being a non-concentric annular structure, is shaped so as to allow the second piece 22 to pass through it complementary manner for mating of the connectors 213, 2214. This is so that the body 221 of the second piece 21 is held at a downwardly inclined altitude in a predefined manner. Per the structure of the second piece 21, the proximal end of the assembled second embodiment 2 is open-ended for shoots of a plant 4 to emerge therefrom during its growth, while the distal end of the assembled second embodiment 2 is closed-ended for retaining the plant therewithin. Moreover, in the assembled second embodiment 2, the concave segment of the first fluid-channeling portion 2121 of the first piece 21 now tapers towards the fluid-collecting portion 2212 of the second piece 22.

Regarding the assembled second embodiment 2, the flanged portions 211, 2211 also contribute to the supportive mounting of the second embodiment 2 on the partition 3 much like the fastening mechanism 215. Since the distal end of the assembled second embodiment 2 is inclined downwards with respect to the proximal end, hence, the weight of the body 221 may cause the second flanged portion 2211 to be in contact with the first flanged portion 211 of the first piece 21, and may further cause the first flanged portion 211 to be in contact with the partition 3 without human intervention. With this, the assembled second embodiment 2 is installed onto the partition 3 with the flanged portions 211, 2211 providing a support for the proximal end of the assembled second embodiment 2 as well. The weight of the body 2211 may further include the weight of the fluids and the plant 4 retained therein.

Regarding the assembled second embodiment 2, the first fluid-channeling portion 2121 and the second fluid-channeling portion 2122 are involved in managing fluid on the assembled second embodiment 2. More specifically, fluid received on any part of the lateral surface of the first fluid-channeling portion 2121 may be made to flow towards its bottom and away from the assembled second embodiment 2 by the influence of gravity, whereas fluid received at the second fluid-channeling portion 2122 may be made to flow towards the fluid-collecting portion 2212. Moreover, in the case where the second fluid-channeling portion 2122 becomes brimmed with fluid (i.e. fluid gathers thereupon faster than it can channel), the excess fluid may spill over to the lateral surface of the first fluid-channeling portion 2121 to flow therealong towards its bottom and away from the first embodiment 1 by the influence of gravity.

Regarding the assembled second embodiment 2, the fluid-collecting portion 2212 and the fluid-draining portion 2213 are also involved in managing fluid on the assembled second embodiment 2. More specifically, the fluid-collecting portion 2212 is to collect fluid that the assembled second embodiment 2 receives from the external environment sources and/or itself for the fluid to be within the body 221 of the assembled second embodiment 2 as shown in FIG. 2, and/or received by a root system of the retained plant 4. Whereas the fluid-draining portion 2213 is to remove excess fluid from the body 221 of the assembled second embodiment 2. Since the fluid-draining portion 2213 is configured so that it may be at a substantial distance from the inclined distal end of the body 221, an amount of fluid may be retained in the body 221. However, once the level of this fluid reaches the fluid-draining portion 2213, the excess fluid is removed from the body 221 of the assembled second embodiment 2 to maintain the level of fluid within body 221.

Regarding the assembled second embodiment 2, the fluid-draining portion 2213 is further involved in providing aeration of the roots of the plant 4, which is shown in FIG. 2. More specifically, the outline of the fluid-draining portion 2213 may guide root growth of the plant 4 during its various growth stages, for a portion of the roots of the plant 4 to grow out from the body 221 for its aeration, and for a portion of the roots of the plant 4 to be retained within the body 221 its nourishment by being immersed in the retained fluid for receiving fluid and nutrients therefrom. It is still noted that the portion of the roots of the plant 4 that grew out from the body 221 may still receive fluid from the fluid-collecting portion 2212 or from the excess fluid that is removed from the body 221 via the fluid-draining portion 2213.

Regarding the second embodiment 2, it is to be noted that the first connector 213 of the first piece 21 and the second connector 2214 of the second piece 22 may not be limited to as described. For example, the first connector 213 may be disposed about any location or position about the first piece 21 and the second connector 2214 may be disposed about any location or position about the second piece 22, as long as they are mateable when the first piece 21 and the second piece 22 are assembled. Moreover, the first connector 213 may alternatively be a protruded segment, while the second connector 2214 may alternatively be a corresponding recessed segment.

Regarding the second embodiment 2, it is to be noted that it provides a degree of customizability since the second piece 22 may be interchanged with another second piece 22 that has a different overall length while still using the same first piece 22. This allows for a large variety of system design choices, such as customisation based on the intended plant varieties to be cultivated, customisation of the partition, or the like.

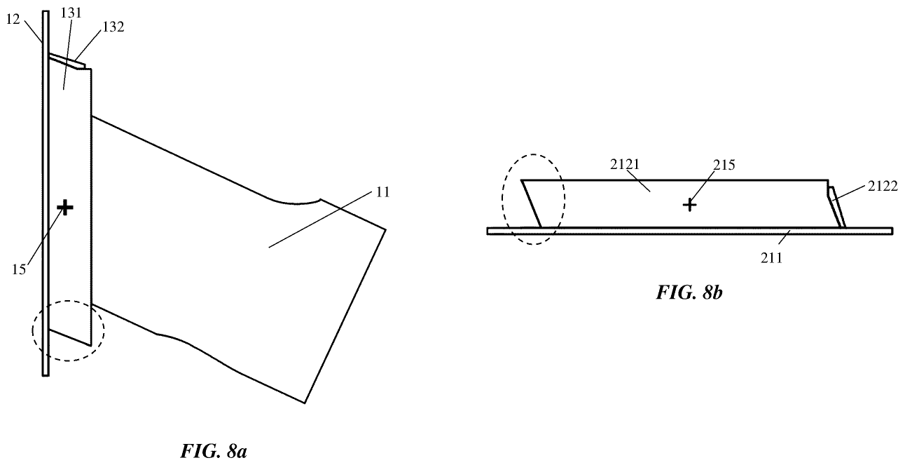

FIGS. 8a and 8b are diagrams illustrating alternative configurations of the first fluid-channeling portion for both embodiments of the apparatus. In particular, FIG. 8a illustrates the first fluid-channeling portion 131 of the first embodiment 1 in an alternative configuration, and FIG. 8b illustrates the first fluid-channeling portion 2121 of the first piece 21 of the second embodiment 2 in an alternative configuration.

As shown in FIG. 8a, at the lower area of the first fluid-channeling portion 131, or at the area of the first fluid-channeling portion 131 that is directly opposite to the second fluid-channeling portion 132, its surface is inclined away from the flanged portion 12 at an angle with respect to the flanged portion 12. More specifically, the said surface in this alternative configuration is to enhance the flow of fluid as the fluid reaches the area of this said surface for the fluid to be directed or diverted away from the apparatus away from the partition 3. Whilst not shown, this said surface may also be configured to be inclined towards the flanged portion 21 at an angle with respect to the flanged portion 21, wherein such a surface may enhance the flow of fluid as the fluid reaches the area of this said surface for the fluid to be directed or diverted away from the apparatus towards the partition 3 for fluid to flow therealong.

As shown in FIG. 8b, at the lower area of the first fluid-channeling portion 2121, or at the area of the first fluid-channeling portion 2121 that is directly opposite to the second fluid-channeling portion 2122, its surface is inclined away from the first flanged portion 211 at an angle with respect to the first flanged portion 211. More specifically, the said surface in this alternative configuration is to enhance the flow of fluid as the fluid reaches the area of this said surface for the fluid to be directed or diverted away from the first apparatus 1 away from the partition 3. Whilst not shown, this said surface may also be configured to be inclined towards the first flanged portion 211 at an angle with respect to the flanged portion 211, wherein such a surface may enhance the flow of fluid as the fluid reaches the area of this said surface for the fluid to be directed or diverted away from the second apparatus 2 towards the partition 3 for fluid to flow therealong.

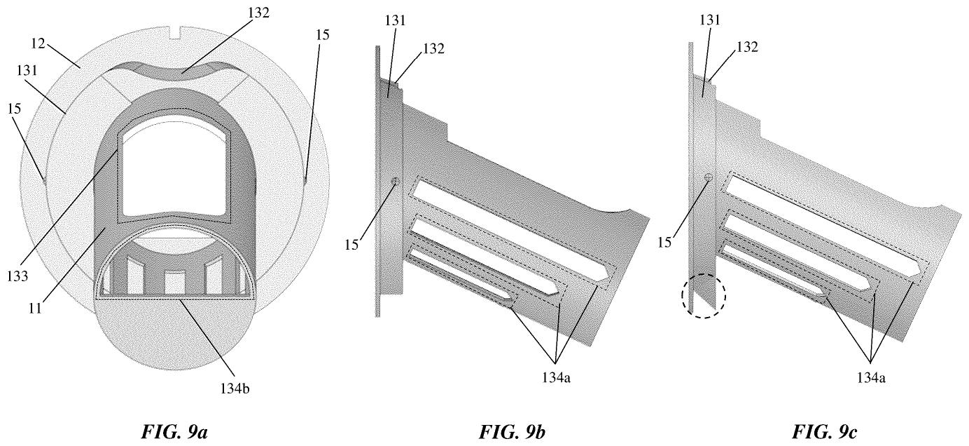

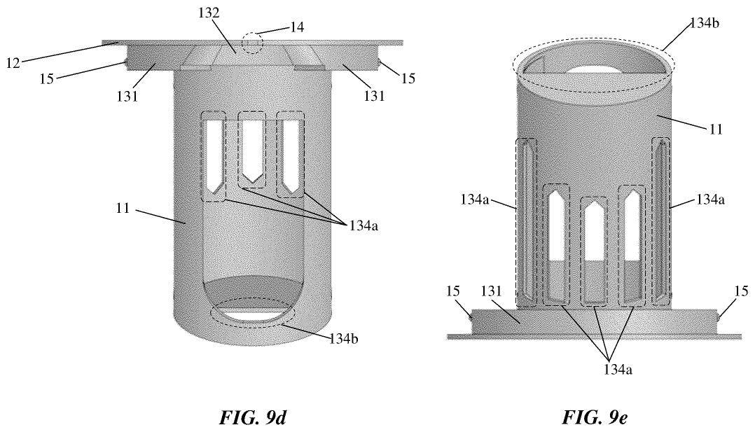

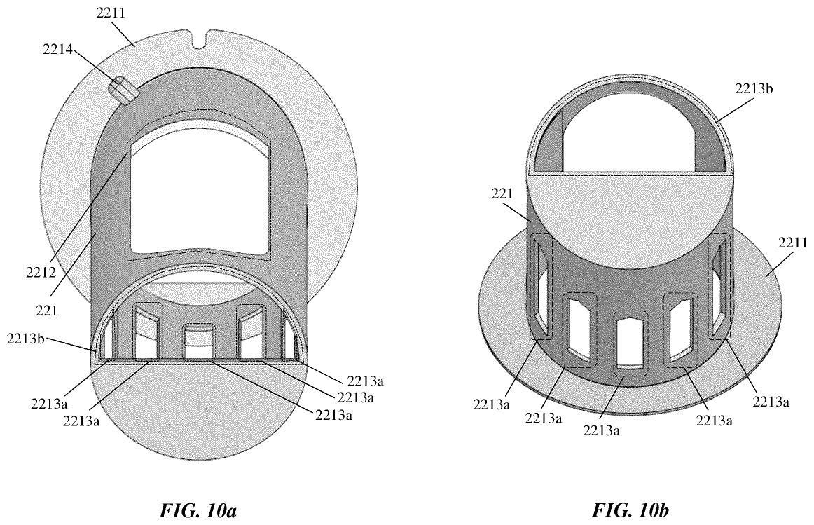

FIGS. 9a to 10b illustrate alternative configurations for more than one fluid-draining portion for the apparatus of the present invention in its various embodiments 1, 2, more specifically, the first embodiment 1 and the second piece 22 of the second embodiment 2. It is to be noted that previous descriptions of the first embodiment 1 and the second piece 22 of the second embodiment 2 may apply to these alternative configurations.

In regards to the first embodiment 1 having more than one fluid-draining portion, FIG. 9a illustrates its rear view, FIG. 9b illustrates its side view, FIG. 9d illustrates its top view, and FIG. 9e illustrates its bottom view. In particular, FIG. 9c illustrates the first embodiment 1 that has an alternative configuration of the first fluid-channeling portion 131 as shown in FIG. 8a, as well as having the alternative configuration of more than one fluid-draining portion.

In regards to the second piece 22 of the second embodiment 2 having more than one fluid-draining portion, FIG. 10a illustrates its rear view, and FIG. 10b illustrates its bottom view. Whilst not shown, there may further be a second embodiment 2 that has an alternative configuration of the first fluid-channeling portion 2121 as shown in FIG. 8b, as well as having the alternative configuration of more than one fluid-draining portion.

As shown in FIGS. 9a to 10b, within these embodiments 1, 2, there is a first set of fluid-draining portions 134a, 2213a on their body 11, 221, which are cutouts with longitudinal outlines formed on the body 11, 221 that extend therealong and substantially tapers towards the distal end of the body 11, 221. Furthermore, within these embodiments 1, 2, the distal end of the body 11, 221 has a partially-closed end in which a second set of fluid-draining portions 134b, 2213b is formed thereon.

Referring to FIGS. 9a to 10b, the first set of fluid-draining portions 134a, 2213a may be cutouts having longitudinal outlines of varying longitudinal lengths, and these cutouts may be cover an entire arc of the body 11, 221 or portions thereof. More specifically, a bottommost fluid-draining portion of the first set of fluid-draining portions 134a, 2213a may be of the shortest longitudinal length, and the other fluid-draining portions of the first set of fluid-draining portions 134a, 2213a may have successively longer longitudinal lengths from the bottommost fluid-draining portion. Moreover, the bottommost fluid-draining portion of the first set of fluid-draining portions 134a, 2213a may be at a substantial distance away from the distal end of the body 11, 221.

Referring to FIGS. 9a to 10b, the second set of fluid-draining portions 134b, 2213b may be a cutout with a shaped outline(s) formed at the distal end of the body 11, 221. The shape may be semicircular, but may be any other permissible shapes. More specifically, the distal end of the body 11, 221 has a partially-closed end in such a way that a lower area of the distal end is walled, while an upper area of the distal end is where the second set of fluid-draining portions 134b, 2213b is formed thereon.

Referring to FIGS. 9a to 10b, with the first set of fluid-draining portions 134a, 2213a and the second set of fluid-draining portions 134b, 2213b configured on the body 11, 221 as such, the removal of excess fluid from body 11, 221 and the retainment of an amount of fluid within the body 11, 221 and are maintained. In particular, once the level of the retained fluid reaches any one or both the first set of fluid-draining portions 134a, 2213a and the second set of fluid-draining portions 134b, 2213b, the excess fluid is removed from the body 11, 221 of the embodiments 1, 2 to maintain the level of fluid within body 11, 221. Moreover, similarly, the first set of fluid-draining portions 134a, 2213a may be involved in providing aeration of the roots of the plant and guiding root growth of the plant.

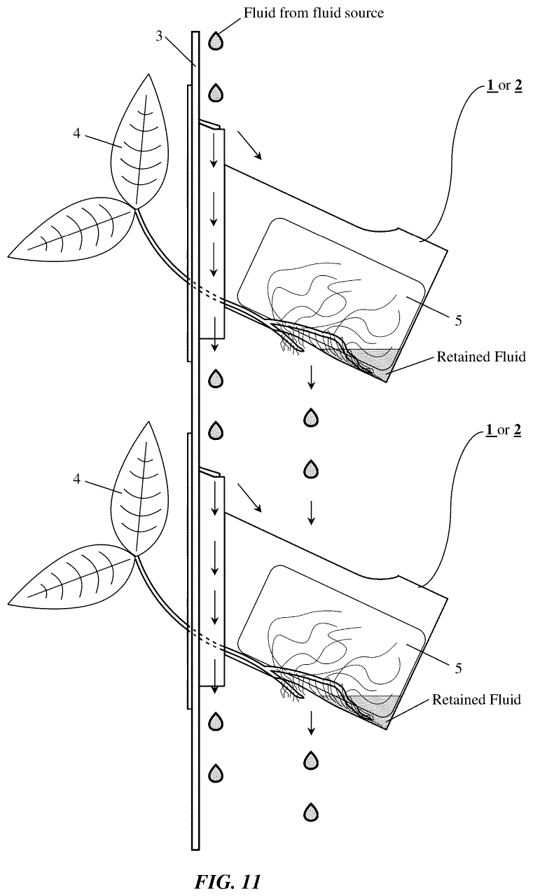

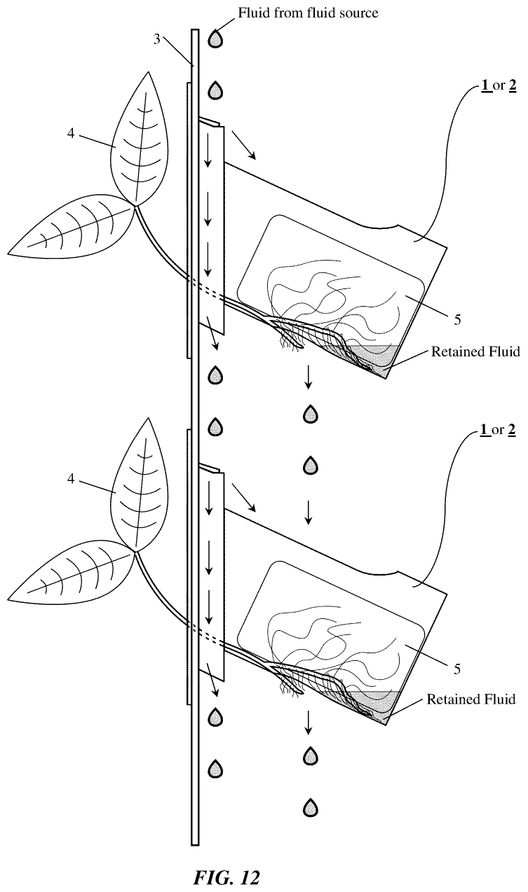

FIGS. 11 and 12 illustrate a sectional side view of the present invention, whereby the apparatuses 1, 2 are installed onto a partition via apertures of the partition, each having growing medium 5 for plants 4 to grow therein the apparatus 1, 2. The growing medium 5 may be, by way of example, perlite, coco coir, Rockwool cubes, vermiculite, peat moss, or the like. Further illustrated in FIG. 11 is an example fluid distribution between the apparatuses 1, 2. It is to be noted that the apparatuses 1, 2 may be either one of the first embodiment 1 or the second embodiment 2 as described beforehand. In particular, for FIG. 12, it is to be further noted that the first fluid-channeling portions 131 2121 of the apparatuses 1, 2 are of the alternative configuration as shown in FIGS. 8a and 8b.

The example setup as shown in FIGS. 11 and 12 may be may be part of a system for horticulture, which may further include a fluid source, a fluid dispensing means, a fluid recovery means, a light source, or the like. Each apparatus 1, 2 in a system for horticulture may be installed on the partition 3 to be located adjacent and equidistant to one another. Hence, each apparatus 1, 2 may be positioned and arranged to be directly beside, above or below each other. As for the fluid used, it may be, by way of example, water, nutrient solutions, liquid fertilizers, or any kind of fluid suitable for use in hydrating and/or nourishing the plants 4. Fluid from the fluid source may be dispensed by the fluid dispensing means by means of dripping, spraying, or trickling in an area that includes the second surface of the partition 3, where the distal end of the apparatus 1, 2 protrudes therefrom.

In an example dispensation of fluid via dripping, fluid may be made to drip from the fluid dispensing means towards one or more topmost apparatuses 1, 2. The fluid-handling portions of the topmost apparatuses 1, 2 will correspondingly handle the fluid received, and may direct portions of the fluid received towards subsequent apparatuses 1, 2 below them, and so forth. Finally, for one or more bottommost apparatuses 1, 2, they direct a portion of the received fluid to a fluid recovery means.

In an example dispensation of fluid via spraying, fluid may be sprayed in the form of a mist by the fluid dispensing means towards the second surface 32 of the partition 3 where the distal end of the apparatuses 1, 2 protrudes therefrom. The fluid that condenses or gathers upon the apparatuses 1, 2 may be received by each of their fluid-handling portions, and each apparatus 1, 2 may direct portions of the fluid received towards subsequent apparatuses 1, 2 below it. Finally, for one or more bottommost apparatuses 1, 2, they direct a portion of the received fluid to a fluid recovery means. In such an example dispensation, the fluid sprayed may also be received by the roots of the plant that that grew out from the apparatus 1, 2.

In an example dispensation of fluid via flowing, fluid may be made to trickle down or stream down the second surface 32 of the partition 3 where the distal end of the apparatuses 1, 2 protrudes therefrom, by the fluid dispensing means. Fluid that gathers upon the apparatuses 1, 2 may be received by each of their fluid-handling portions, and each apparatus 1, 2 may direct portions of the fluid received towards subsequent apparatuses 1 2 below it. Finally, for one or more bottommost apparatuses 1, 2, they direct a portion of its received fluid to a fluid recovery means.

The handling of fluid by each apparatus 1, 2 for fluid distribution between them shall now be described:
Fluid received by the first fluid-channeling portion 131, 2121 of the apparatus 1, 2, preferably via its lateral surface, may be directed towards a subsequent apparatus 1, 2. More specifically, the second fluid-channeling portion 132, 2122 of the subsequent apparatus 1, 2.
Fluid received by the second fluid-channeling portion 132, 2122 of the apparatus 1, 2, may be directed towards its fluid-collecting portion 133, 2212.
Fluid received by the fluid-collecting portion 133, 2212 of the apparatus 1, 2 may be directed towards a root system of the retained plant 4 and/or be retained within the body 11, 221.
Fluid that overflows out from body 11, 221 of the apparatus 1, 2 via its fluid-draining portion 134, 2213 may be directed towards a subsequent apparatus 1, 2. More specifically, the fluid-collecting portion 133, 2212 of the subsequent apparatus 1, 2.

In particular, when fluid received by the first fluid-channeling portion 131, 2121 of the apparatus 1, 2 flows along its lateral surface and reaches a lower area or an area that is directly opposite to the second fluid-channeling portion 132, 2122, the fluid may
flow in a neutral direction to reach a subsequent apparatus 1, 2 as shown in FIG. 11, in the case where the said area of the first fluid-channeling portion 131, 2121 is configured to be without inclination;
flow in a direction away from the partition 3 to reach a subsequent apparatus 1, 2, as shown in FIG. 12, in the case where the said area of the first fluid-channeling portion 131, 2121 is configured to be inclined away from the partition 3; or
flow in a direction towards the partition 3 to reach a subsequent apparatus 1, 2 (not shown), in the case where the said area of the first fluid-channeling portion 131, 2121 is configured to be inclined towards the partition 3.

It should be noted that the illustrations of FIG. 11 and FIG. 12 are not intended to be interpreted as limitations to the present invention. The apparatus 1, 2 of FIG. 11 and FIG. 12 may be installed onto one partition 3 of the same.

Whilst not shown, it is to be noted that the descriptions of FIG. 11 and FIG. 12 are applicable to apparatuses 1, 2 that have more than one fluid-draining portion as shown in FIGS. 9a to 10b.

With this, the details pertaining to an apparatus 1, 2 for horticulture that is to be mounted onto a partition 3 for the cultivation of a plant 4 therewithin, along with a system for horticulture involving it, have been elucidated. Whilst the apparatus 1, 2 had been described to be primarily involved in a vertical farming setting, it is to be noted that it may be readily generalised by a person skilled in the art for usage in any horticulture systems and/or methods known in the art.

It is to be noted that, although the terms first, second, etc. may have been used to describe various elements, components, regions, pieces or sections, these elements, components, regions, pieces or sections should not be limited by these terms. These terms were only used to distinguish one element, component, region, piece or section from another region, piece or section. Thus, a first element, component, region, piece or section as discussed above could be termed a second element, component, region, piece or section without departing from the teachings of the present invention.

The present disclosure includes the appended claims and the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. An apparatus for horticulture, comprising
an elongate body that retains a plant therewithin,
a flanged portion at a proximal end of the apparatus; and
one or more fluid-handling portions that include
a first fluid-channeling portion at the proximal end of the apparatus in which the flanged portion extends therefrom; and
a second fluid-channeling portion that is formed on the first fluid-channeling portion;
wherein
the body is inclined relative to a plane having the flanged portion with a distal end of the apparatus extending in a downwardly inclined altitude with respect to the flanged portion, with the flanged portion supporting the installation of the apparatus into an aperture of a vertical structure having levelled surfaces for fluid received by the apparatus to be handled by one or a combination of the fluid-handling portions where
the first fluid-channeling portion directs received fluid away from the apparatus; and
the second fluid-channeling portion directs fluid towards the body.

2. The apparatus according to claim 1, wherein the fluid-handling portions further include
a fluid-collecting portion formed on the body; and
at least one fluid-draining portion formed on the body;
wherein
the fluid-collecting portion allows receipt of fluid from the environment and/or itself into the body; and
the fluid-draining portion drains excess fluid within the body away from the apparatus.

3. The apparatus according to claim 2, wherein the fluid-draining portion is at a distance away from the distal end of the apparatus for retaining a portion of received fluid within the body for immersing roots of the plant therein.

4. The apparatus according to claim 2, wherein the fluid-draining portion is formed with an outline that is tapered towards the distal end of the apparatus for guiding root growth of a plant to be external of the body for its aeration.

5. The apparatus according to claim 1, further comprising a fastening mechanism formed along a lateral surface of the first fluid-channeling portion as a set of protrusions for providing a support at the proximal end of the apparatus as the apparatus is installed on the vertical structure.

6. The apparatus according to claim 1, further comprising an orientation marker formed on the flanged portion for serving as an indication of a proper orientation of the apparatus whereby it is at a topmost level along the flanged portion.

7. The apparatus according to claim 1, wherein
the first fluid-channeling portion and the second fluid-channeling portion are part of a first piece; and
the fluid-collecting portion and the fluid-draining portion are part of a second piece;
wherein the first piece and the second piece are capable of being assembled to form the apparatus.

8. The apparatus according to claim 7, wherein the first piece and the second piece each include a connector that is mateable with each other for the first piece and the second piece to be detachably connected for their assembly.

9. The apparatus according to claim 1, wherein the body is inclined relative to a plane having the flanged portion with a distal end of the apparatus extending in a downwardly inclined altitude with respect to the flanged portion at an angle that is between 50° and 80°.

10. A system for horticulture, comprising
a vertical structure having levelled surfaces, formed with a plurality of apertures;
a fluid dispensing means for dispensing fluid; and
a plurality of apparatuses for horticulture that each includes
an elongate body that retains a plant therewithin,
a flanged portion at a proximal end of the apparatus; and
one or more fluid-handling portions that include;
a first fluid-channeling portion at the proximal end of the apparatus in which the flanged portion extends therefrom; and
a second fluid-channeling portion that is formed on the first fluid-channeling portion;
wherein the body of each apparatus is inclined relative to a plane having the flanged portion with a distal end of the apparatus extending in a downwardly inclined altitude with respect to the flanged portion, with the flanged portion supporting the installation of the apparatus into one aperture of the vertical structure for fluid dispensed by the fluid-dispensing means to be received by the apparatus for it handled by one or a combination of the fluid-handling portions where
the first fluid-channeling portion directs received fluid away from the apparatus; and
the second fluid-channeling portion directs fluid towards the body.

11. The system according to claim 10, wherein the fluid-handling portions of the apparatus further include
a fluid-collecting portion formed on the body; and
at least one fluid-draining portion formed on the body;
wherein
the fluid-collecting portion allows receipt of fluid from the environment and/or itself into the body; and
the fluid-draining portion drains excess fluid within the body away from the apparatus.

12. The system according to claim 11, wherein the fluid-draining portion of the apparatus is at a distance away from the distal end of the apparatus for retaining a portion of received fluid within the body for immersing roots of the plant therein.

13. The system according to claim 11, wherein the fluid-draining portion of the apparatus is formed with an outline that is tapered towards the distal end of the apparatus for guiding root growth of a plant to be external of the body for its aeration.

14. The system according to claim 11, wherein the apparatus further comprises a fastening mechanism formed along a lateral surface of the first fluid-channeling portion as a set of protrusions for providing a support at the proximal end of the apparatus as the apparatus is installed on the vertical structure.

15. The system according to claim 11, wherein the apparatus further comprises an orientation marker formed on the flanged portion for serving as an indication of a proper orientation of the apparatus whereby it is at a topmost level along the flanged portion.

16. The system according to claim 11, wherein the apparatus is in the form of assemblable pieces where
the first fluid-channeling portion and the second fluid-channeling portion are part of a first piece; and
the fluid-collecting portion and the fluid-draining portion are part of a second piece;
wherein the first piece and the second piece are capable of being assembled to form the apparatus.

17. The system according to claim 16, wherein the first piece and the second piece of the apparatus each include a connector that is mateable with each other for the first piece and the second piece to be detachably connected for their assembly.

18. A kit of parts assembly for horticulture, comprising
a first piece and a second piece, with
an elongate body that retains a plant therewithin being part of the second piece;
a flanged portion being part of either one or both the first piece and the second piece; and
one or more fluid-handling portions being part of either one or both the first piece and the second piece that include;
a first fluid-channeling portion that is part of the first piece; and
a second fluid-channeling portion that is part of the first piece, which is formed on the first fluid-channeling portion;
wherein
the first piece and the second piece are detachably connectable with each other; and
assembly of the pieces provides an assembled piece where
the first fluid-channeling portion is at a proximal end of the assembled piece; and
the body is inclined relative to a plane having the flanged portion with a distal end of the assembled piece extending in a downwardly inclined altitude with respect to the flanged portion, with the flanged portion supporting the installation of the assembled piece into an aperture of a vertical structure having levelled surfaces for fluid received by the assembled piece to be handled by one or a combination of the fluid-handling portions where
the first fluid-channeling portion that is part of the first piece directs received fluid away from the assembled piece; and
the second fluid-channeling portion directs fluid towards the body of the assembled piece.
